(19) United States
(12) Patent Application Publication
(10) Pub. No.: US 2020/0263836 A1
(43) Pub. Date: Aug. 20, 2020

(54) Hazardous Material Transportation System

(71) Applicant: Donald E. Knudslien, Entwistle (CA)

(72) Inventor: Donald E. Knudslien, Entwistle (CA)

(21) Appl. No.: 16/279,993

(22) Filed: Feb. 19, 2019

(51) Int. Cl. F17D 1/08; F17D 5/02

(52) U.S. Cl. CPC F17D 1/088; F17D 5/02

(57) ABSTRACT

A pipeline system that is configured to provide safe transportation of a hazardous material wherein the pipeline system encapsulates the hazardous material in a transport pellet. The pipeline system of the present invention includes a pipeline that is constructed to initiate at a first destination and terminate at the same destination so as to provide a continuous path therebetween. The pipeline has disposed therein a transport media that is configured to flow within the pipeline along the continuous path. The transport media of the present invention is non-toxic so as to prevent damage to the environment in the event of a pipeline compromise. A plurality of transport pellets are provided wherein the transport pellets include a durable outer casing defining an interior volume. Hazardous material is disposed within the transport pellet and the transport pellet is suspended in the transport media for transportation.

### FIELD OF INVENTION

The present invention relates generally to point to point transportation of hazardous materials such as but not limited to bitumen, more specifically but not by way of limitation, a looped pipeline system wherein the hazardous materials are transported therein being encased in pellets.

### BACKGROUND

Hazardous materials are transported utilizing numerous types of methods. Depending upon the material, its source and destination various modes of transport are deployed for point to point transportation of hazardous materials such as but not limited to petrochemical products like oil and other chemicals. Conventional transportation can includes barges and/or trucks wherein the material is typically generated or processed at a plant/facility and then is shipped to a destination wherein the facility at the destination may use the material as an input into their manufacturing process. Transportation via trucks, ships and/or barges are typically utilized for lower volume of transportation wherein the material may need to be transported to various facilities and on routine schedules.

Another method of transportation of materials such as but not limited to oil are pipelines. Pipelines are utilized to move product from generation/processing facilities in large quantities and on a regular basis. In North America there are approximately 72,000 miles of pipeline that are utilized for crude oil and other similar products. Inherent with the utilization of pipelines are the risks associated with spills. Pipelines can become damaged from a result of accidents or as part of the aging process. Damage to pipelines often results in spills that typically have a negative impact on the environment. Additionally, conventional pipelines are known to have leaks and small amounts of the material being transported therein is introduced to the environment and can as such have harmful effects thereon. Another issue with pipelines is that they are typically created for a point to point distribution and the flow therein is often executed in just one direction.

Accordingly, there is a need for a pipeline system configured to transport a hazardous material safely wherein the pipeline system of the present invention includes a transport media that is environmentally friendly and further provides encasement of the hazardous materials in a non-dissolvable shell.

### SUMMARY OF THE INVENTION

It is the object of the present invention to provide a pipeline system that is configured to transport hazardous materials wherein the pipeline system is designed to flow in a continuous loop with at least two destination points integrated with the pipeline system.

Another object of the present invention is to provide a pipeline system that is configured to provide environmentally safe transportation of hazardous materials such as but not limited to bitumen, wherein the pipeline system utilizes a transport media that is non-toxic to the environment.

A further object of the present invention is to provide a pipeline system that is configured to transport hazardous materials wherein the pipeline system utilizes materials such as but not limited to water or vegetable oil as a transport media.

Yet a further object of the present invention is to provide a pipeline system that is configured to provide environmentally safe transportation of hazardous materials such as but not limited to bitumen, wherein the pipeline system includes a multitude of material pellets configured to have a hazardous material disposed therein.

Still another object of the present invention is to provide a pipeline system that is configured to transport hazardous materials wherein the material pellets include an outer casing that is manufactured from a durable non-dissolvable material in the transport media.

An additional object of the present invention is to provide a pipeline system that is configured to provide environmentally safe transportation of hazardous materials such as but not limited to bitumen, wherein the material pellets are suspended in the transport media for transportation thereof.

Yet a further object of the present invention is to provide a pipeline system that is configured to transport hazardous materials wherein the material pellets are disposed within the pipeline at a first point and extracted from the pipeline at a second point.

Another object of the present invention is to provide a pipeline system that is configured to provide environmentally safe transportation of hazardous materials such as but not limited to bitumen, wherein the pipeline is constructed in a continual loop formation so as to facilitate the consistent flow of transport media through the entire loop.

An alternate object of the present invention is to provide a pipeline system that is configured to transport hazardous materials wherein the outer casing of the material pellets can be dissolved in a solvent of other material so as to access the hazardous material therefrom.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of a pipeline configuration of the present invention; and

FIG. 2 is a diagrammatic cross-sectional view of the pipeline of the present invention; and

FIG. 3 is a diagrammatic view of an exemplary transport pellet of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a pipeline system 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

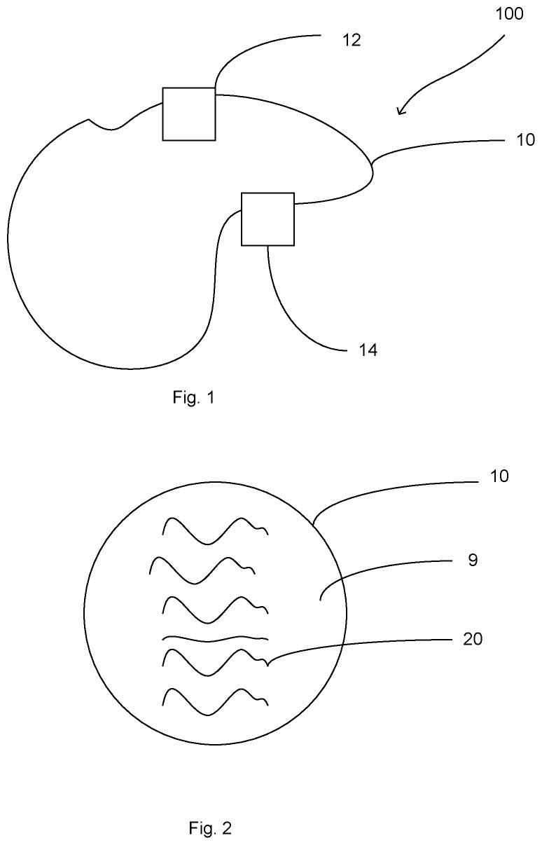

Referring in particular to the Figures submitted herewith, the pipeline system 100 includes a pipeline 10. The pipeline 10 is a conventionally constructed pipeline manufactured from steel or other suitable material. It is contemplated within the scope of the present invention that the pipeline 10 could be manufactured in numerous alternate diameters. Furthermore, it should be understood within the scope of the present invention that the pipeline 10 could be manufactured in various lengths by way of example but not limitation from short distances like a mile or two to hundreds of miles in length. The pipeline 10 illustrated herein in FIG. 1 is exemplary only and does not serve to define the shape of the pipeline or the size thereof. The pipeline 10 of the present invention is manufactured so as to form a continuous loop. The pipeline 10 can be formed in any shape but the pipeline 10 is connected so as to provide continual flow of a transport media 20 as will be further discussed herein.

The pipeline 10 includes access points 12, 14. Access points 12, 14 are constructed so as to provide access to the interior volume 9 of the pipeline 10 for the purpose of either depositing or extracting transport pellets 30. It is contemplated within the scope of the present invention that the access points 12, 14 could be constructed in numerous alternate manners so as to facilitate the engagement with the interior volume 9 of the pipeline 10. This could include but is not limited to construction to facilitate manual access to the interior volume 9 of the pipeline 10. Alternatively, the access points 12, 14 could be constructed so as to operably couple with machinery or the like to facilitate the introduction and/or extraction of the transport pellets 30.

While the pipeline 10 is illustrated herein as having two access points 12, 14, it should be understood by those skilled in the art that the pipeline 10 could be manufactured with alternate quantities of access point 12, 14 that could be greater than the two illustrated herein. It should be further understood within the scope of the present invention that the access points 12, 14 could be located anywhere along the pipeline 10.

Referring now to FIG. 2, a cross-section of the pipeline 10 is illustrated therein. The pipeline 10 has disposed within the interior volume 9 thereof a transport media 20. The transport media 20 moves within the interior volume 9 of the pipeline 10 in a continuous manner wherein the flow thereof is always moving in consistent direction. While the flow pattern of the transport media 20 can be reversed, it is to be understood within the scope of the present invention that the transport media 20 flows continuously through the pipeline 10. In order to achieve the desired objective of the present invention wherein the objective is to inhibit damage to the environment, the transport media 20 is a substance such as but not limited to water or vegetable oil. The aforementioned serve as examples only and it should be understood within the scope of the present invention that the transport media 20 could be numerous alternate substances and achieved the desired objective. The transport media 20 is manufactured from a non-toxic substance so in the event of a compromise of the pipeline 10 any spillage of the transport media 20 will not result in environmental damage.

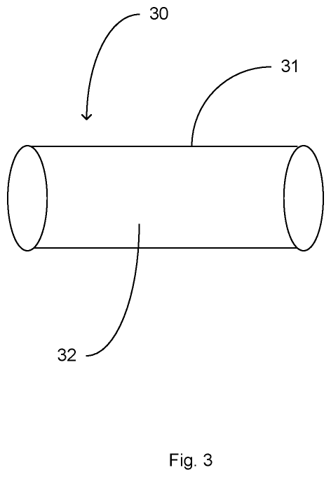

Referring now to FIG. 3, a diagrammatic view of an exemplary transport pellet 30 of the present invention is illustrated therein. The transport pellet 30 is configured to receive and store therein a hazardous material such as but not limited to bitumen. The transport pellet 30 includes an outer casing 31 that is manufactured from a material that is non-dissolvable in the transport media 20. By way of example but not limitation, the outer casing 31 could be manufactured from a polymer. It is desired within the scope of the present invention that the outer casing 31 is durable enough to maintain integrity during the physical movement in the pipeline 10 and in the event of a pipeline catastrophe have sufficient strength so as to not break or compromise when ejected from the pipeline 10. The aforementioned facilitates retrieval thereof subsequent an event with the pipeline 10 that caused the release of the transport pellets 30 into the environment. It is contemplated within the scope of the present invention that the outer casing 31 could be manufactured from numerous alternate suitable materials.

The interior volume 32 has bitumen or another desired material stored therein. While the transport pellet 30 has been illustrated herein as being cylindrical in shape, it is contemplated within the scope of the present invention that the transport pellet 30 could be manufactured in alternate shapes and sizes. It is further contemplated within the scope of the present invention that the outer casing 31 could be constructed of a material that is dissolvable in a solvent. A solvent dissolvable outer casing 31 would facilitate the removal of the material disposed within the transport pellet 30. For the aforementioned, it is contemplated that the material could be extracted from the mixture ensuing the dissolving of the outer casing 31 in a solvent so as to provide for an operator of the pipeline system 100 the hazardous material as well as an opportunity to recycle and/or reuse the material of the outer casing 31.

It should be understood within the scope of the present invention that the transport pellets 30 could be constructed with valves or similar elements wherein the valves would facilitate the deposit or retrieval of a substance disposed within the interior volume 32 of the transport pellet 30. For this embodiment, the outer casing 31 would be manufactured from a material that is not dissolvable in a solvent.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A pipeline system configured to transport a hazardous material comprising:
a pipeline, said pipeline being constructed so as to be intermediate a first destination and at least one alternate destination, said pipeline configured to have a continuous return from the at least one alternate destination and the first destination;
a transport media, said transport media being disposed in said pipeline, said transport media operable to flow continuously through said pipeline;
at least one transport pellet, said at least one transport pellet configured to be suspended in said transport media, said at least one transport pellet configured to have a hazardous material disposed therein, said at least one transport pellet being introduced into said pipeline at said first destination and extracted at said at least one alternate destination.

2. The pipeline system as recited in claim 1, wherein said at least one transport pellet includes an outer casing, said outer casing being manufactured from a material that is non-dissolvable in said transport media.

3. The pipeline system as recited in claim 2, wherein said outer casing of said at least one transport material defines an interior volume of the at least one transport pellet, said outer casing further being puncture resistant.

4. (canceled)

5. The pipeline system as recited in claim 3, wherein said outer casing of said at least one transport pellet is manufactured from a polymer, wherein said polymer is dissolvable in a solvent.

6. The pipeline system as recited in claim 5, wherein said at least one transport pellet is manufactured in a shape selected from one of the following: round or cylindrical.

7. A pipeline system configured to transport a hazardous material so as to avoid contamination of the environment in which the pipeline system is present in the event of a compromise of the pipeline system wherein the pipeline system comprises:
a pipeline, said pipeline being constructed so as to initiate at a first destination and terminate at the first destination, said pipeline configured so as to have a continuous flow therethrough from the first destination and return to the first destination;
a transport media, said transport media being disposed in said pipeline, said transport media operable to flow continuously through said pipeline, said transport material being of sufficient volume to fill said pipeline, said transport media being manufactured from a non-toxic material;
a plurality of transport pellets, said plurality of transport pellets configured to be suspended in said transport media, said plurality of transport pellets configured to have a hazardous material disposed therein, said plurality of transport pellets being introduced into said pipeline at said first destination and extracted at a point located along said pipeline, said plurality of transport pellets being puncture resistant, said plurality of transport pellets having an outer casing, said outer casing being manufactured from a polymer, wherein the polymer is dissolvable in a solvent so as to facilitate extraction of the hazardous material disposed within the plurality of transport pellets.

8. (canceled)

9. (canceled)

10. The pipeline system as recited in claim 7, wherein said transport media is a material that is selected from one of the following materials: water or vegetable oil.

11. The pipeline system as recited in claim 10, wherein said plurality of transport pellets are manufactured in a shaped selected from one of the following: round or cylindrical.

12. (canceled)

13. (canceled)
